(19) United States
(12) Patent Application Publication
(10) Pub. No.: US 2003/0182456 A1
(43) Pub. Date: Sep. 25, 2003

(54) Portable peripheral apparatus with an embedded storage module

(75) Inventors: Ju-Yung Lin, Taipei (TW); Hao-Hsing Lin, Taipei (TW)

Correspondence Address: Richard P. Berg, Esq., c/o LADAS & PARRY, Suite 2100, 5670 Wilshire Boulevard, Los Angeles, CA, 90036-5679, US

(73) Assignee: Acer Laboratories Inc.

(21) Appl. No.: 10/152,197

(22) Filed: May 20, 2002

(30) Foreign Application Priority Data
Mar. 1, 2002 (TW) 91103860

(51) Int. Cl. G06F 15/16

(52) U.S. Cl. 709/250; 710/13

(57) ABSTRACT

A portable peripheral apparatus with an embedded storage module. The apparatus is connected to a computer via a communication interface, such as a USB interface or an IEEE 1394 interface. The portable peripheral apparatus includes a main device and an embedded storage module. The embedded storage module connects to the computer via the communication interface and has a storage device. The storage device stores peripheral data. If the storage device is a rewritable memory, then when receiving a specific instruction from the computer, the embedded storage module receives and updates the peripheral data stored in the storage device.

### BACKGROUND OF THE INVENTION

1. Field of the Invention

The Invention relates to a portable peripheral apparatus and, in particular, to a portable peripheral apparatus with an embedded storage module.

2. Description of the Related Art

With the advance of the computer technology, the performance and speed of the CPU has greatly improved. Since various specifications of serial buses have been proposed, such as the Universal Serial Bus (USB) and the Institute of Electrical and Electronic Engineers (IEEE) 1394 interface (known as FireWire), modern computer peripheral devices often connect to computers with serial buses.

When a conventional peripheral device, such as a USB peripheral device, connects to a computer, the device can only operate with driver installed. If a peripheral device itself has the function of storage, such as a removable hard disk drive, the driver can be stored in a storage portion of the peripheral device. However, referring to FIG. 1, if a peripheral device 120, such as a printer, does not have the function of storage itself, a computer 110 cannot obtain the driver directly from the peripheral device 120. For a peripheral device 120 connecting to a computer via a communication interface 150 such as a USB or an IEEE 1394 interface, the computer may obtain the driver from an additional storage medium, such as a floppy disk 130 or a CD-ROM 140.

One disadvantage of the above technique is that when a user loses the floppy disk 130 or the CD-ROM 140, or when the user brings the peripheral device without the floppy disk 130 or the CD-ROM 140, the peripheral device 120 cannot operate since the driver cannot be obtained.

Moreover, some peripheral devices may have specific utilities, or may have BIOS data modified. Some other peripheral devices, such as a modem for network connection, may cause security problems. Therefore, they preferably include security protection programs, such as virus protection software. In conventional peripheral devices, these programs must be stored in additional storage media such as floppy disks or CD-ROMs as mentioned above. Thus, they also suffer from inconvenience caused by loss or lack of access to additional storage media.

Furthermore, since the drivers, utilities, BIOS data, security protection programs, or other peripheral data required are stored in additional floppy disks or CD-ROMs, it is inconvenient to update them. For example, when a new version of the driver or virus code is released, a user must update the data on the floppy disk or CD-ROM manually, or obtain a new floppy disk or CD-ROM. This adds to the inconvenience for the user.

### SUMMARY OF THE INVENTION

In view of the above, an object of the invention is to propose a portable peripheral apparatus with an embedded storage module to improve the peripheral device with a communication interface such as a serial bus. The embedded storage module can store a driver, a utility, BIOS data, a security program, or any other required peripheral data, so that a plug-and-play peripheral device can be realized without requiring an additional floppy disk or CD-ROM.

The invention discloses a portable peripheral apparatus that connects to a computer via a communication interface. The portable peripheral apparatus according to the invention includes a main device and an embedded storage module. The main device and the embedded storage module connect to the computer via the communication interface. The embedded storage module has a storage device, which stores peripheral data.

The invention also discloses a method for a computer to access peripheral data, wherein the computer is connected with a portable peripheral apparatus via a communication interface. The method includes controlling the communication interface using a communication interface control module; controlling the embedded storage module according to a standard storage specification; performing data compilation on the storage device according to a program control interface specification, such as the AT Attachment Packet Interface (ATAPI) specification; coordinating the operations of the main device and the embedded storage module using an arbitration control module; and accessing the peripheral data in the storage device.

According to the invention, the communication interface may be a USB or an IEEE 1394 interface. The storage device may be a read-only memory (ROM), a rewritable memory, or a flash memory. If the storage device is a rewritable memory, then the embedded storage module may receive and update the peripheral data in the storage device when receiving a specific instruction from the computer.

According to the invention, the peripheral data stored in the storage device may be the driver of the main device, utilities, BIOS data, security protection programs, or other peripheral data required by the main device

These and other features, aspects and advantages of the invention will become better understood with regard to the following description and accompanying drawing.

### BRIEF DESCRIPTION OF THE DRAWINGS

The present invention can be more fully understood by reading the subsequent detailed description in conjunction with the examples and references made to the accompanying drawings, wherein:

FIG. 1 is a schematic diagram showing a peripheral apparatus in the prior art;

FIG. 2 is a schematic diagram showing the architecture of the portable peripheral apparatus according to an embodiment of the invention;

FIG. 3 is a schematic diagram showing the architecture of the portable peripheral apparatus connecting to two computers according to another embodiment of the invention; and

FIG. 4 is a flowchart showing the steps of peripheral data accessing according to an embodiment of the invention.

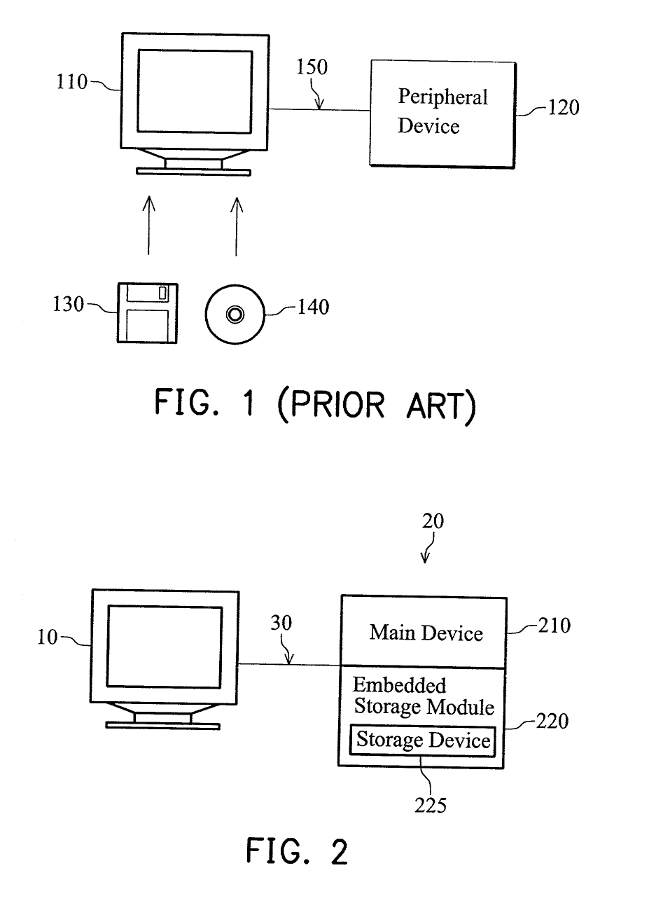

### DETAILED DESCRIPTION OF THE INVENTION

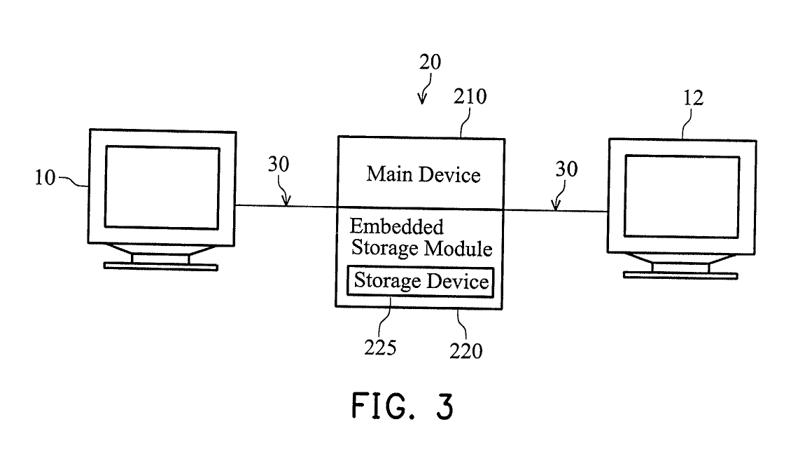

Please refer to FIG. 2 and FIG. 3, which illustrate the architecture of the portable peripheral apparatus with an embedded storage module according to an embodiment of the invention.

FIG. 2 shows the portable peripheral apparatus 20 according to an embodiment of the invention. The portable peripheral apparatus 20 connects to a computer 10 via a communication interface 30, such as a USB interface or an IEEE 1394 interface. The present embodiment utilizes a USB interface as the communication interface 30 for illustration.

The portable peripheral apparatus 20 according to the embodiment of the invention includes a main device 210 and an embedded storage module 220. The main device 210 is the principle part of the portable peripheral apparatus 20, such as a printer, an MP3 player, or a modem. The embedded storage module 220 is embedded in the main device 210 to minimize the size and weight of the portable peripheral apparatus 20. The main device 210 and the embedded storage module 220 both connect to the computer 10 via the communication interface 30 to communicate with the computer 10.

Furthermore, the embedded storage module 220 includes a storage device 225, such as a ROM, a RAM, or a Flash memory. In the present embodiment, a rewritable Flash memory MM is utilized as the storage device 225. The storage device 225 stores the peripheral data of the peripheral apparatus 20, such as the driver of the main device 210, utilities, BIOS data, security protection programs, or other peripheral data required by the main device 210.

In the present embodiment, since the communication interface 30 of the portable peripheral apparatus 20 utilizes the USB interface, the embedded storage module 220 can be compatible with the standard USB mass-storage device class, so that the computer 10 can read the data stored in the storage device 225 of the embedded storage module 220. If the portable peripheral apparatus 20 utilizes the IEEE 1394 interface, or other interface such as the developing Device Bay interface, the embedded storage module 220 can be designed to be compatible with other interface standards for the computer 10 to read the stored data.

When the portable peripheral apparatus 20 is connected with the computer 10 via the USB interface 30, the computer 10 can read and install the data, such as the driver of the main device 210, stored in the storage device 225 via the USB interface 30, so that the main device 210 can operate. Moreover, if the computer 10 needs a utility or a security protection program, or to modify its BIOS data while communicating with the main device 210, the computer 10 can also read the data required from the storage device 225 via the USB interface 30 to perform the operation.

Furthermore, if the computer 10 finds out that the peripheral data needs to be updated while connected to the portable peripheral apparatus 20, the computer 10 can update the peripheral data stored in the storage device 225 through a specific update mechanism. For example, when the driver or the security program has a newer version, the computer can send a specific instruction to the embedded storage module 220. After receiving the specific instruction, the embedded storage module 220 can receive and update the peripheral data stored in the storage device 225. Through this mechanism, the peripheral data can be updated in real time. No additional manual update procedure is required.

FIG. 3 shows the portable peripheral apparatus 20 according to another embodiment of the invention. The portable peripheral apparatus 20 in the present embodiment can be a network connection apparatus, such as a USB network connection apparatus.

In the present embodiment, being substantially the same as the embodiment previously described, the portable peripheral apparatus 20 connects to computers 10 and 12 via a communication interface 30, such as a USB interface or an IEEE 1394 interface. The portable peripheral apparatus 20 also includes a main device 210 and an embedded storage module 220. The main device 210 performs the network connection functions between the computer 10 and the computer 12. The peripheral data, such as the driver of the main device 210, utilities, BIOS data, security protection programs, or other peripheral data required by the main device 210, are stored in the storage device 225 of the embedded storage module 220. By this arrangement, any of the computers 10 and 12 can read data stored in the storage device 225 via the USB interface 30.

Moreover, in the present embodiment, the computers 10 and 12 can have different authority levels for accessing the peripheral data stored in the portable peripheral apparatus 20. For example, if the computer 10 is a server and the computer 12 is a terminal, the computer 10 can have a higher authority level to update the peripheral data stored in the portable peripheral apparatus 20. The computer 12 can have a lower authority level under which updates to the peripheral data are not allowed. Therefore, when the peripheral data stored in the portable peripheral apparatus 20 needs to be updated, only the computer 10 can send a specific instruction to update the peripheral data in the storage device 225 as described in the previous embodiment.

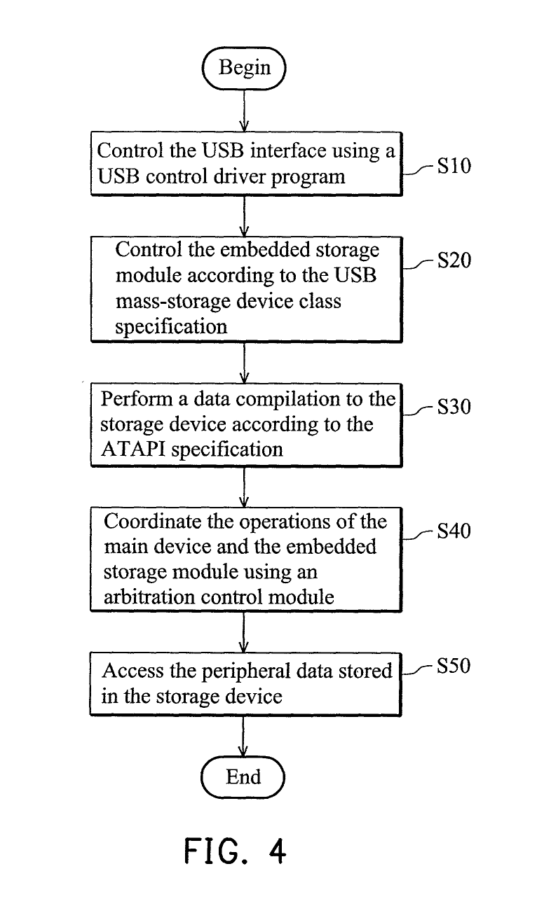

FIG. 4 shows the procedure of a computer accessing the peripheral data stored in the embedded storage module of the portable peripheral apparatus according to the embodiments of the invention described above.

First, if the portable peripheral apparatus 20 is connected with the computer 10, the computer 10 controls the USB interface 30 via a communication interface control module, such as a USB control driver program (step S10). The computer 10 also controls the embedded storage module 220 according to a standard storage specification, such as the USB mass-storage device class specification (step S20). Then, data compilation is performed on the storage device 225 (step S30) according to a program control interface specification, such as the common AT Attachment Packet Interface (ATAPI) specification. An arbitration control module is used to coordinate the operations, such as the transmission operations of the USB interface of the main device 210 and the embedded storage module 220 (step S40). By this way, the computer 10 can read or update the peripheral data stored in the storage device 225 (step S50)

While the present invention has been described with reference to the preferred embodiments thereof, it is to be understood that the invention is not limited to the described embodiments or constructions. On the contrary, the invention is intended to cover various modifications and similar arrangements as would be apparent to those skilled in the art. Therefore, the scope of the appended claims should be accorded the broadest interpretation so as to encompass all such modifications and similar arrangements.

What is claimed is:

1. A portable peripheral apparatus connected to a computer via a communication interface, the peripheral device comprising:
a main device connected to the computer via the communication interface; and
an embedded storage module connected to the computer via the communication interface, the embedded storage module having a storage device.

2. The portable peripheral apparatus according to claim 1, wherein the communication interface is a universal serial bus (USB) interface.

3. The portable peripheral apparatus according to claim 2, wherein the embedded storage module is compatible with the USB mass-storage device class specification.

4. The portable peripheral apparatus according to claim 1, wherein the communication interface is an Institute of Electrical and Electronic Engineers (IEEE) 1394 interface.

5. The portable peripheral apparatus according to claim 1, wherein the storage device comprises a read-only memory (ROM).

6. The portable peripheral apparatus according to claim 1, wherein the storage device comprises a rewritable memory.

7. The portable peripheral apparatus according to claim 6, wherein when the embedded storage module receives a specific instruction form the computer, the embedded storage module receives and updates the peripheral data stored in the storage device.

8. The portable peripheral apparatus according to claim 1, wherein the storage device comprises a flash memory.

9. The portable peripheral apparatus according to claim 1, wherein the peripheral data comprises a driver program of the main device.

10. The portable peripheral apparatus according to claim 1, wherein the peripheral data comprises Basic Input Output System (BIOS) data.

11. The portable peripheral apparatus according to claim 1, wherein the peripheral data comprises a utility program required by the main device.

12. The portable peripheral apparatus according to claim 1, wherein the peripheral data comprises a security protection program.

13. A method for a computer to access peripheral data, the computer being connected with a portable peripheral apparatus via a communication interface, the portable peripheral apparatus having a main device and an embedded storage module, the embedded storage module having a storage device to store the peripheral data, the method comprising the steps of:
controlling the communication interface using a communication interface control module;
controlling the embedded storage module according to a standard storage specification;
performing data compilation on the storage device according to a program control interface specification; and
accessing the peripheral data in the storage device.

14. The method for a computer to access peripheral data according to claim 13, wherein the communication interface is a USB interface.

15. The method for a computer to access peripheral data according to claim 14, wherein the standard storage specification is the USB mass-storage device class specification.

16. The method for a computer to access peripheral data according to claim 14, wherein the communication interface control module is a USB control driver program.

17. The method for a computer to access peripheral data according to claim 13, wherein the program control interface specification is the AT Attachment Packet Interface (ATAPI) specification.

18. The method for a computer to access peripheral data according to claim 13, further comprising the step of:
coordinating the operations of the main device and the embedded storage module using a arbitration control module.

19. The method for a computer to access peripheral data according to claim 13, further comprising the step of:
receiving and updating, by the embedded storage module, the peripheral data stored in the storage device storage device when the embedded storage module receives a specific instruction from the computer.
